(19) United States
(12) Patent Application Publication
(10) Pub. No.: US 2026/0360913 A1
(43) Pub. Date: Nov. 12, 2026

(54) HOUSING, IN PARTICULAR FOR AN ENERGY STORE

(71) Applicant: DEUTZ AKTIENGESELLSCHAFT, Köln (DE)

(72) Inventor: Oliver HOFFMANN, Grafschaft (DE)

(21) Appl. No.: 19/137,919

(22) PCT Filed: Dec. 11, 2023
(86) PCT No.: PCT/EP2023/085119

§ 371 Date: Jun. 11, 2025

(30) Foreign Application Priority Data
Dec. 23, 2022 (DE) 10 2022 004 898.1

(51) Int. Cl. H01M 50/308; H01M 50/204; H01M 50/249; H01M 50/262

(52) U.S. Cl. CPC H01M 50/308; H01M 50/249; H01M 50/262; H01M 50/204

(57) ABSTRACT

A housing, in particular for an energy storage device, including a housing wall having a housing outer wall portion, a housing partition wall portion and a housing inner wall portion, where a venting aperture for venting the housing extends through the housing outer wall portion, the housing partition wall portion and the housing inner wall portion along a longitudinal axis (L19), and where the housing outer wall portion and the housing inner wall portion are spaced apart from one another in the axial direction and the housing partition wall portion is arranged axially between the housing outer wall portion and the housing inner wall portion, and wherein the venting aperture is formed at least partially by an opening in the housing partition wall portion, which is arranged in axial direction in complete overlap with the housing inner wall portion, and an opening in the housing outer wall portion, and wherein the opening in the housing partition wall portion is arranged completely in axial overlap with the opening in the housing outer wall portion.

### TECHNICAL FIELD

The present disclosure relates to a housing, in particular for an energy storage device of an electrical or electromechanical drive unit, in particular a battery housing of an electrical or electromechanical drive unit.

### BACKGROUND

Housings for energy storage devices have the purpose of accommodating the energy storage device and protecting it from environmental influences. Furthermore, housings for energy storage devices can include interfaces for transferring electrical energy between individual energy storage devices or to a load. In addition, housings for energy storage devices must have venting devices to equalize the internal pressure acting in the housing to the ambient pressure and to prevent the pressure inside the enclosure from rising too quickly and too high during thermal runaway of the energy storage device.

A battery, in particular for use in a vehicle, is known from WO 2010/012339 A1. The battery comprises a battery housing that has an opening to reduce internal pressure. In the area of the opening there is a pipe attachment with labyrinth-like formations for the removal of outgases.

### BRIEF SUMMARY

An aspect of the disclosure is to provide a housing, in particular for an energy storage device of an electrical or electromechanical drive unit, in particular a battery housing of an electrical or electromechanical drive unit, which comprises a vent that ensures protection against direct contact with the energy storage device accommodated in the housing and is easy to manufacture.

This is accomplished with a housing, in particular for an energy storage device, is proposed comprising a housing wall comprising a housing outer wall portion, a housing partition wall portion and a housing inner wall portion, wherein a venting aperture for venting the housing extends through the housing outer wall portion, the housing partition wall portion and the housing inner wall portion along a longitudinal axis, and wherein the housing outer wall portion and the housing inner wall portion are spaced apart from one another in the axial direction and the housing partition wall portion is arranged axially between the housing outer wall portion and the housing inner wall portion, and wherein the venting aperture is formed at least partially by an opening in the housing partition wall portion, which is arranged in axial direction in complete overlap with the housing inner wall portion, and an opening in the housing outer wall portion, and wherein the opening in the housing partition wall portion is arranged completely in axial overlap with the opening in the housing outer wall portion.

The housing has the advantage that, due to the arrangement of the opening in the housing partition wall portion in complete axial overlap with the opening in the housing outer wall portion, these openings can be produced in a joint work step and using the same tool. This significantly reduces the processing time of the vent. In addition, reaching through the venting aperture through the housing inner wall portion is prevented.

In a possible embodiment of the housing, the housing inner wall portion can have an opening that is arranged in the axial direction without overlap with the opening in the housing partition wall portion.

In a further possible embodiment of the housing, the opening of the housing partition wall portion can comprise multiple opening sections. The multiple opening sections can be arranged rotationally symmetrically around the longitudinal axis. Each of the multiple opening sections can be arranged in axial direction in complete overlap with the housing inner wall portion and with the opening in the housing outer wall portion.

An embodiment of the housing is conceivable in which the opening or the multiple opening sections in the housing partition wall portion can comprise a circular ring opening section. The circular ring opening section can be arranged in the form of a circular ring segment around the longitudinal axis. The circular ring opening section can also be limited by a first outer diameter and a first inner diameter.

A further embodiment of the housing is conceivable in which the opening in the housing outer wall portion can comprise one or more circular ring opening sections. The one or more circular ring opening sections can be arranged in the form of a circular ring segment around the longitudinal axis. Multiple circular ring opening sections can be provided, which are arranged at a distance from each other in a circumferential direction around the longitudinal axis. The one or more circular ring opening sections can define a circular segment-shaped section of the outer contour of the opening in the housing outer wall portion with a second outer diameter.

In a further possible embodiment of the housing, the opening in the housing outer wall portion can be designed in such a way that one or more retaining sections of the housing outer wall portion extend from radially outwards to radially inwards. The one or more retaining sections can have a circular segment-shaped section of an outer contour of the opening in the housing outer wall portion with a third outer diameter. The second outer diameter can be larger than the third outer diameter. Alternatively or in combination, the first outside diameter can be equal to the second outside diameter. Several retaining sections can be provided, which are arranged at a distance from each other in a circumferential direction around the longitudinal axis.

It will be understood by those skilled in the art that the outer contour of an opening corresponds to the inner contour of the wall that defines the opening.

In a possible embodiment of the housing, a circular ring opening section of the opening in the housing outer wall portion can be delimited in the circumferential direction on a first side by a first retaining section and on the opposite second side by a second retaining section.

In a further possible embodiment, a surrounding chamber can be formed between the housing outer wall portion and the housing partition wall portion. The surrounding chamber can be delimited by a first cylindrical envelope arranged around the longitudinal axis, which has a fourth outer diameter. The housing outer wall portion can be arranged to overlap the surrounding chamber in the axial direction, at least partially.

An inner chamber can be formed between the housing partition wall portion and the housing inner wall portion. The inner chamber can be delimited by a second cylindrical envelope arranged around the longitudinal axis, which has a fifth outer diameter.

The fourth outer diameter can be larger than the first outer diameter, the second outer diameter and/or the third outer diameter. Alternatively or in combination, the fifth outer diameter can be the same as the first outer diameter and/or the second outer diameter.

In another possible embodiment, a venting element can be inserted into the venting aperture. The housing outer wall portion can have connecting means via which the venting element can be connected or is connected to the housing outer wall portion. In particular, the housing outer wall portion is not circular, so that the venting element can be connected to the housing outer wall portion in a form-fitting and/or force-fitting manner at least in one direction of rotation about the longitudinal axis. In particular, the venting element can comprise one or more clamping sections that can be clamped or are clamped to the housing outer wall portion. The one or more clamping sections can be arranged at least partially in the surrounding chamber and engage behind the one or more retaining sections of the housing outer wall portion.

### BRIEF DESCRIPTION OF THE DRAWINGS

An embodiment of the housing is explained below with reference to the drawings. Herein

FIG. 1 is a perspective view of a housing for a battery;

FIG. 2 is a perspective view of a wall element of the housing from FIG. 1;

FIG. 3 is a front view of the wall element from FIG. 2;

FIG. 4 is a detailed view of the wall element from FIG. 2 according to detail IV from FIG. 3;

FIG. 5 is a sectional view through the wall element from FIG. 2 along the section line V-V according to FIG. 4;

FIG. 6 is a sectional view through the wall element from FIG. 2 along the section line VI-VI according to FIG. 5;

FIG. 7 is a sectional view through the wall element from FIG. 2 along the section line VII-VII according to FIG. 5;

FIG. 8 is a view analogous to the view in FIG. 2 with the venting element inserted; and

FIG. 9 is a view analogous to the view in FIG. 5 with inserted venting element.

### DETAILED DESCRIPTION

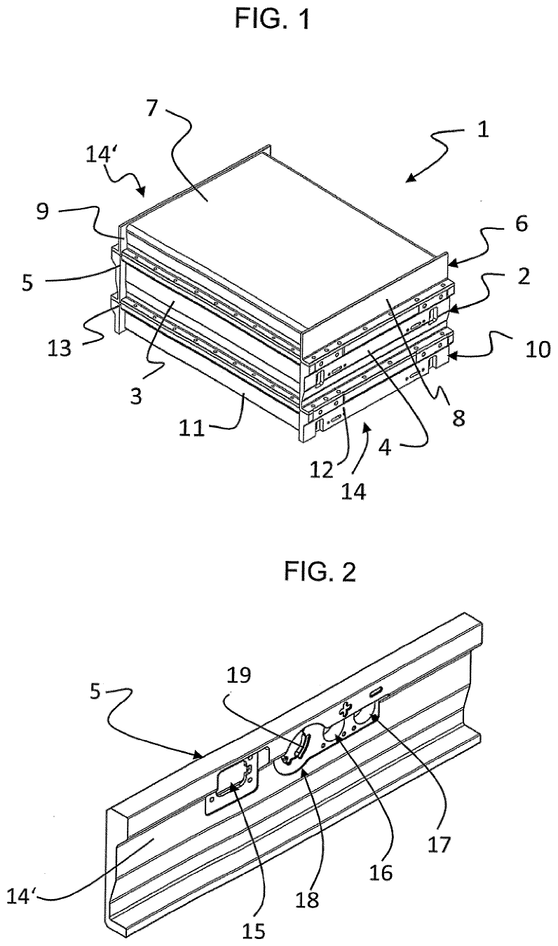

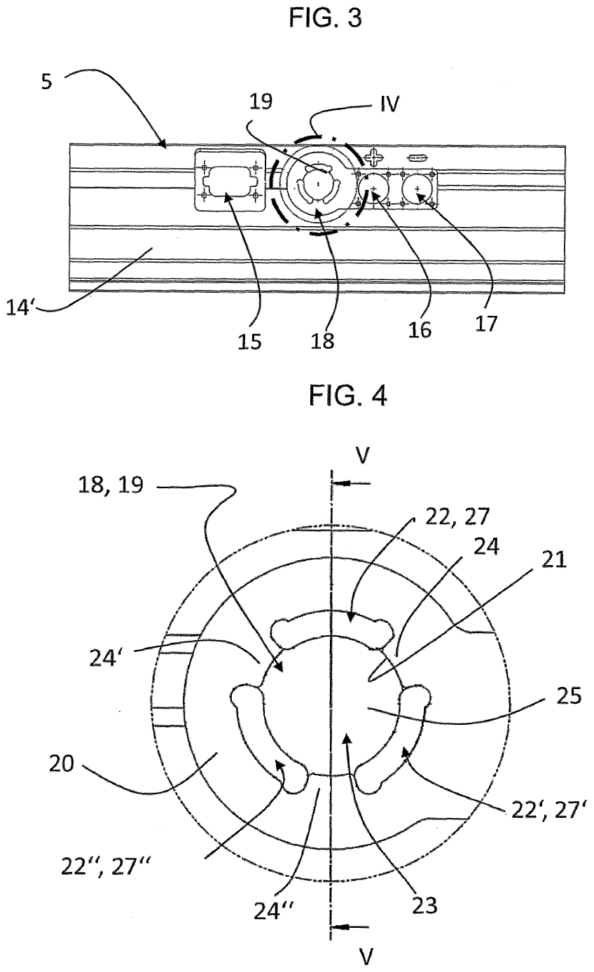

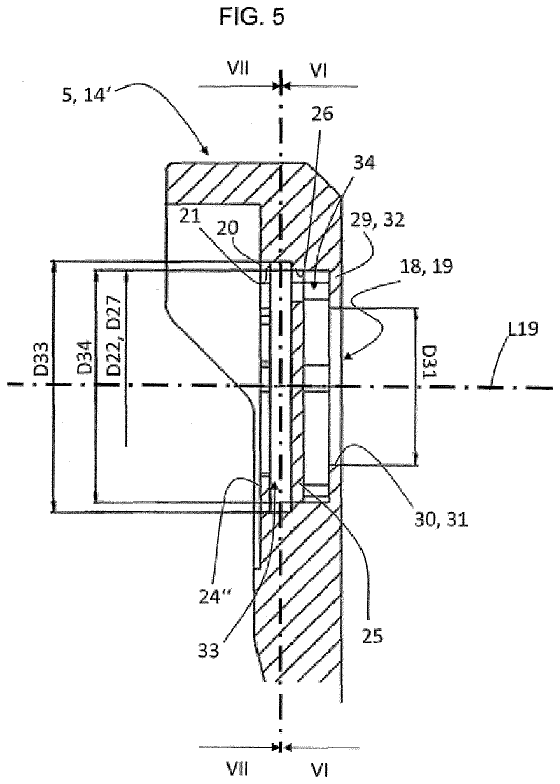

FIGS. 1 to 9, described together below, show a housing 1, for a battery of a electric motor drive unit. The housing 1 comprises an intermediate unit 2, an end unit 6 and a receiving unit 10. The end unit 6 is connected to the intermediate unit 2 by means of screws distributed around the circumference, so that a first housing chamber is formed between the end unit 6 and the intermediate unit 2. The receiving unit 10 is connected to the intermediate unit 2 by means of screws distributed around the circumference, so that a second housing chamber is formed between the receiving unit 10 and the intermediate unit 2. The first housing chamber contains a first energy storage device in the form of a battery. The second housing chamber also contains a second energy storage device in the form of a battery.

The intermediate unit 2 comprises an intermediate element 3, which has a prismatic basic shape, with an H-shaped base face extending along a longitudinal axis of the housing. The intermediate unit 2 further comprises a first cover element 4 and a second cover element 5. The first cover element 4 is firmly connected to the intermediate element 3 at a first front face of the housing 1. The second cover element 5 is firmly connected to the intermediate element 3 on the opposite second front face of the housing 1.

The end unit 6 comprises an end element 7, which has a prismatic basic shape with a U-shaped base face extending in the direction of the longitudinal axis. The end unit 7 comprises a first cover element 8 and a second cover element 9. The first cover element 8 is firmly connected to the end element 7 at the first front face of the housing 1. The second cover element 9 is firmly connected to the end element 7 at the second opposite front face of the housing 1.

The receiving unit 10 comprises a receiving element 11 that has a prismatic basic shape with a U-shaped base face. The receiving unit 10 comprises a first cover element 12 and a second cover element 13. The first cover element 12 is firmly connected to the receiving element 11 at the first front face of the housing 1. The second cover element 13 is firmly connected to the receiving element 11 at the second opposite front face of the housing 1.

The first cover elements 4, 8, 12 thus form a first housing wall 14 on the first front face of the housing 1 and the second cover elements 5, 9, 13 form a second housing wall 14′ on the second front face of the housing 1. In the second cover element 5 of the intermediate unit 2, the second housing wall 14′ has an aperture for a coolant connection 15, an aperture for an interface 16 of the positive terminal of the batteries, an aperture for an interface 17 of the negative terminal of the batteries and a venting aperture 19 for a vent 18.

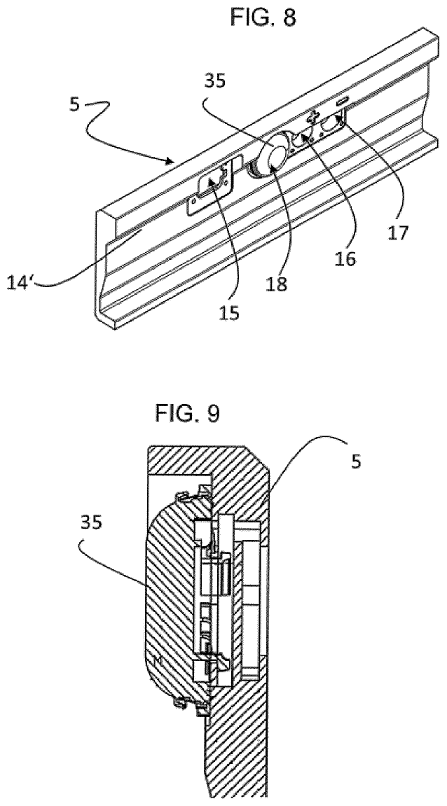

The internal pressure acting in the housing is equalized to the ambient pressure via the venting aperture 19 and the pressure inside the enclosure is prevented from rising too quickly and too high during thermal runaway of the energy storage device. In addition, the venting aperture 19 is designed in such a way that a venting element 35 can be fastened in it, as shown in particular in FIGS. 8 and 9.

The venting aperture 19 extends along a longitudinal axis L19 through the second housing wall 14′ or through the second cover element 5. The longitudinal axis L19 extends parallel to the longitudinal axis of the housing 1. The second housing wall 14′ or the second cover element 5 has a housing outer wall portion 20, a housing partition wall portion 25 and a housing inner wall portion 29 in the area of the venting aperture 19.

The housing outer wall portion 20 delimits the second housing wall 14′ in the direction of an environment of the housing 1. The housing inner wall portion 29 delimits the second housing wall 14′ in the direction of the interior of the housing 1, in particular in the direction of the first and/or the second housing chamber.

The housing outer wall portion 20 is axially spaced from the housing partition wall portion 25 with respect to the longitudinal axis L19. A surrounding chamber 33 is arranged between the housing outer wall portion 20 and the housing partition wall portion 25. The surrounding chamber 33 is designed as a straight cylinder which extends coaxially to the longitudinal axis L19 and has a diameter D33. In other words, the surrounding chamber 33 is delimited by an envelope arranged cylindrically around the longitudinal axis L19, which has the diameter D33. The diameter D33 is larger than the diameter D27, the diameter D22 and the diameter D23.

The housing partition wall portion 25 is in turn axially spaced from the housing inner wall portion 29 with respect to the longitudinal axis L19. In other words, the housing partition wall portion 25 is arranged between the housing outer wall portion 20 and the housing inner wall portion 29. A inner chamber 34 is arranged between the housing partition wall portion 25 and the housing inner wall portion 29. The inner chamber 34 is designed as a straight cylinder that extends coaxially to the longitudinal axis L19 and has a diameter D34. In other words, the inner chamber 34 is delimited by an envelope end arranged cylindrically around the longitudinal axis L19, which has the diameter D34. The diameter D34 is greater than or equal to the diameter D27 and the diameter D22.

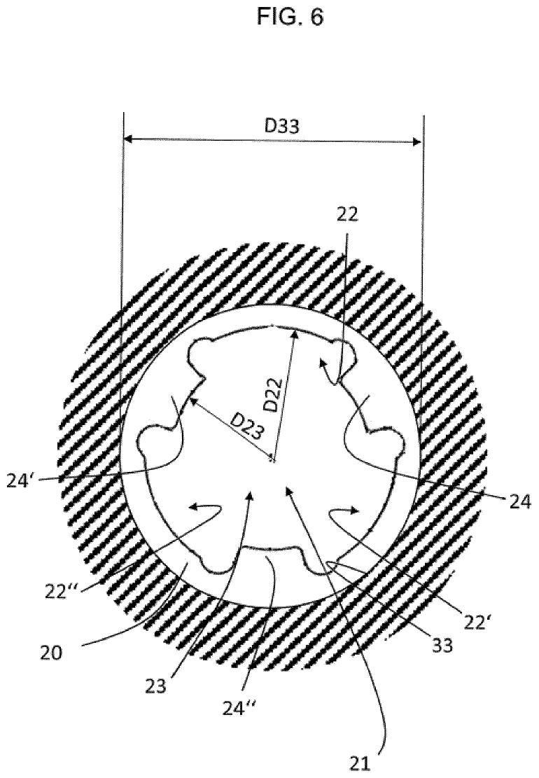

The housing outer wall portion 20 comprises a opening 21 which extends coaxially to the longitudinal axis L19 through the housing outer wall portion 20. As can be seen in particular from the combined view of FIGS. 4 and 6, the opening 21 is defined by the superimposition of a central circular opening section 23 with three circular ring opening sections 22, 22′, 22″. In other words, the housing outer wall portion 20 is deviating from a circular ring shape.

The circular ring opening sections 22, 22′, 22″ are arranged rotationally symmetrically with respect to the longitudinal axis L19 at equal distances from one another. The circular ring opening sections 22, 22′, 22″ are each formed as circular ring segments around the longitudinal axis L19, which extend in a direction parallel to the longitudinal axis L19. Thus, the circular ring opening sections 22, 22′, 22″ each describe a circular segment-shaped section of the outer contour of the opening 21, which has an outer diameter D22.

The circular opening section 23 is cylindrical in shape and extends coaxially to the longitudinal axis L19 with a diameter D23. The outer diameter D22 of the circular ring opening sections 22, 22′, 22″ is larger than the outer diameter D23 of the circular opening section 23.

The circular ring opening sections 22, 22′, 22″ are each delimited on both sides in a circumferential direction around the longitudinal axis L19 by retaining sections 24, 24′, 24″. The retaining sections 24, 24′, 24′ extend from radially outside to radially inside up to the diameter D23. The retaining sections 24, 24′, 24″ are arranged in a direction parallel to the longitudinal axis L19 in overlap with the surrounding chamber 33.

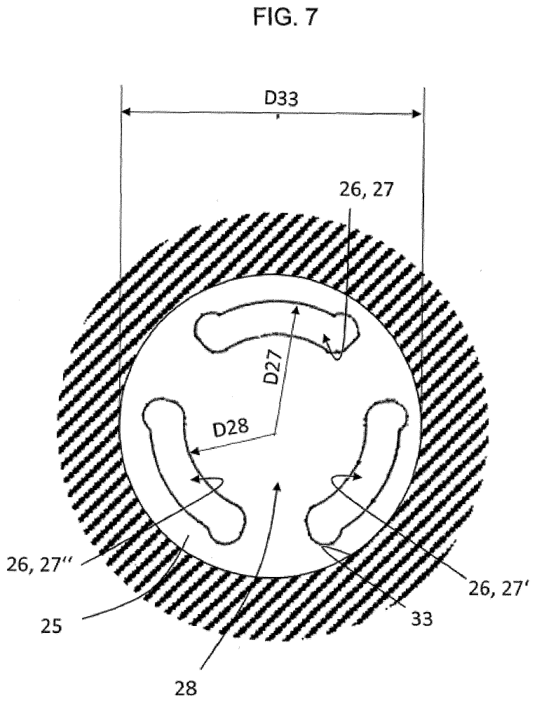

The housing partition wall portion 25 comprises an opening 26 formed by three circular ring opening sections 27, 27′, 27″, as can be seen in particular in FIG. 7. The circular ring opening sections 27, 27′, 27″ are arranged rotationally symmetrically with respect to the longitudinal axis L19 at equal distances from one another. The circular ring opening sections 27, 27′, 27″ are each formed as circular ring segments around the longitudinal axis L19, which extend in a direction parallel to the longitudinal axis L19. The circular ring opening sections 27, 27′, 27″ each form a circular segment-shaped section of the opening 26, which has an outer diameter D27 and an inner diameter D28.

The circular ring opening section 27, 27′, 27″ in the housing partition wall portion 25 are arranged in a direction parallel to the longitudinal axis L19 in complete overlap with the opening 21 in the housing outer wall portion 20. In other words, a projection of the circular ring opening section 27, 27′, 27″ in the housing partition wall portion 25 in the direction of the opening 21 and parallel to the longitudinal axis L19 is completely projected on the opening 21. In particular, one of the circular ring opening section 27, 27′, 27″ in each case is arranged in the housing partition wall portion 25 in a direction parallel to the longitudinal axis L19 in complete overlap with one of the circular ring opening section 22, 22′, 22″ in the housing outer wall portion 20. The outer diameter D27 is also equal to the second diameter D22.

The circular ring opening section 27, 27′, 27″ in the housing partition wall portion 2 and the circular ring opening section 22, 22′, 22″ in the housing outer wall portion 20 can be produced by a common milling process. In other words, the opening 26 of the housing partition wall portion 25 can be created at the same time as the opening 21 of the housing outer wall portion 20 is machined.

Due to the rotationally symmetrical arrangement of the circular ring opening sections 27, 27′, 27″ with respect to the longitudinal axis L19, the housing partition wall portion 25 comprises a central tripod section 28, which is formed from a cylinder section arranged coaxially to the longitudinal axis L19 and three connecting sections projecting therefrom.

The housing inner wall portion 29 comprises a opening 30 formed by a circular opening section 31. The housing inner wall portion 29 is arranged in the axial direction with respect to the longitudinal axis L19 without overlapping the opening 26 in the housing partition wall portion 25. The circular opening section 31 is designed as a straight cylinder which extends coaxially to the longitudinal axis L19 with a diameter D31 through the housing inner wall portion 29.

The diameter D31 is smaller than the inner diameter D28 of the opening 26 or the circular ring opening sections 27, 27′, 27″. Thus, a circular ring-shaped cover section 32 is formed by the housing inner wall portion. The circular ring opening sections 27, 27′, 27″ are arranged in the axial direction with respect to the longitudinal axis L19 completely overlapping the cover section 32. The cover section 32 thus prevents a straight reach from an outer side of the housing 1 into the interior of the housing 1 via the circular ring opening section 27, 27′, 27″.

The venting aperture 19 thus comprises the opening 21 of the housing outer wall portion 20, the opening 26 of the housing partition wall portion 25, the opening 30 of the housing inner wall portion 29, the inner chamber 34 and the outer chamber 33.

1. Housing, in particular for an energy storage device, comprising:
a housing wall comprising a housing outer wall portion a housing, partition wall portion and a housing inner wall portion
wherein a venting aperture for venting the housing extends through the housing outer wall portion, the housing partition wall portion and the housing inner wall portion along a longitudinal axis,
wherein the housing outer wall portion and the housing inner wall portion are spaced apart from each other in the axial direction, and the housing partition wall portion is arranged axially between the housing outer wall portion and the housing inner wall portion, and
wherein the venting aperture is formed at least partially by an opening in the housing partition wall portion, which is arranged in the axial direction in complete overlap with the housing inner wall portion, and an opening in the housing outer wall portion, and
wherein the opening in the housing partition wall portion is arranged completely in axial overlap with the opening in the housing outer wall portion.

2. Housing according to claim 1, wherein the housing inner wall portion has an opening which is arranged in the axial direction without overlap with the opening in the housing partition wall portion.

3. Housing according to claim 1, wherein the opening of the housing partition wall portion comprises a plurality of opening sections which are arranged rotationally symmetrically about the longitudinal axis, and wherein each of the plurality of opening sections is arranged in axial direction in complete overlap with the housing inner wall portion and with the opening in the housing outer wall portion.

4. Housing according to claim 1, to wherein the opening or the multiple opening sections in the housing partition wall portion comprise a circular ring opening section, which is arranged in the form of a circular ring segment around the longitudinal axis and is delimited by a first outer diameter and a first inner diameter.

5. Housing according to claim 1, wherein the opening in the housing outer wall portion comprises one or more circular ring opening sections, which is/are arranged in the form of a circular ring segment around the longitudinal axis.

6. Housing according to claim 5, wherein the one or more circular ring opening sections define a circular segment-shaped section of the outer contour of the opening in the housing outer wall portion with a second outer diameter.

7. Housing according to claim 1, wherein the opening in the housing outer wall portion is configured such that one or more retaining sections of the housing outer wall portion extend from radially outwards to radially inwards.

8. Housing according to claim 7, wherein the one or more retaining sections have a circular segment-shaped section of an outer contour of the opening in the housing outer wall portion with a third outer diameter.

9. Housing according to claim 8, wherein the second outer diameter is greater than the third outer diameter, and/or wherein the first outer diameter is equal to the second outer diameter.

10. Housing according to claim 5, wherein a circular ring opening section of the opening in the housing outer wall portion is delimited in the circumferential direction on a first side by a first retaining section and on the opposite second side by a second retaining section.

11. Housing according to claim 1, wherein a surrounding chamber is formed between the housing outer wall portion and the housing partition wall portion and that an inner chamber is formed between the housing partition wall portion and the housing inner wall portion.

12. Housing according to claim 11, wherein the surrounding chamber is delimited by a first envelope arranged cylindrically around the longitudinal axis and having a fourth outer diameter, and wherein the inner chamber is delimited by a second envelope arranged cylindrically around the longitudinal axis and having a fifth outer diameter.

13. Housing according to claim 12, wherein the fourth outer diameter is greater than the first outer diameter, the second outer diameter and/or the third outer diameter, and/or wherein the fifth outer diameter is equal to the first outer diameter and/or the second outer diameter.

14. Housing according to claim 1, wherein a venting element is inserted into the venting aperture, and wherein the venting element comprises one or more clamping sections which are arranged clamped with the housing outer wall portion.

15. Housing according to claim 14, wherein the one or more clamping sections are arranged at least partially in the surrounding chamber and engage behind the one or more retaining sections of the housing outer wall portion.
